(19) United States
(12) Patent Application Publication
(10) Pub. No.: US 2021/0016280 A1
(43) Pub. Date: Jan. 21, 2021

(54) MICROFLUIDIC PACKAGE, HOLDER, NAD METHODS OF MAKING THE SAME

(71) Applicant: CytoRecovery, Inc., Blacksburg, VA (US)

(72) Inventor: Robert A. Flesher, Baltimore, MD (US)

(21) Appl. No.: 16/932,264

(22) Filed: Jul. 17, 2020

Related U.S. Application Data
(60) Provisional application No. 62/876,265, filed on Jul. 19, 2019.

(51) Int. Cl. B01L 3/00

(52) U.S. Cl. CPC B01L 3/502715; B01L 2300/0816; B01L 2300/0893; B01L 2300/0829; B01L 2300/0645

(57) ABSTRACT

Microfluidic package devices are disclosed. In one aspect of the disclosure an example microfluidic package device includes a resilient layer on top of a substrate, where the resilient layer defines at least one sample receiving well above at least one sample receiving portion and at least one outlet well above the at least one outlet portion and the resilient layer defines at least one electrode well above that at least one electrode receiving portion. Microfluidic package holders are also disclosed. Example microfluidic package holders include moveable electrodes and carrier interface cards that align with the resilient layer.

### RELATED APPLICATION

This application claims priority to U.S. provisional application 62/876,265, filed on Jul. 19, 2019, the entirety of which is incorporated by reference herein.

### FIELD OF THE INVENTION

The present invention relates to devices and methods for dielectrophoresis (DEP) for manipulation of cells or particles. The devices and methods of the present invention provide for improved DEP devices and systems for interfacing with DEP devices.

### BACKGROUND OF THE INVENTION

Isolation and enrichment of cells/micro-particles from a biological sample is one of the first crucial processes in many biomedical and homeland security applications. Water quality analysis to detect viable pathogenic bacterium and the isolation of rare circulating tumor cells (CTCs) for early cancer detection are important examples of the applications of this process. Conventional methods of cell concentration and separation include centrifugation, filtration, fluorescence activated cell sorting, or optical tweezers. Each of these techniques relies on different cell properties for separation and has intrinsic advantages and disadvantages. For instance, many of the known techniques require the labeling or tagging of cells in order to obtain separation. These more sensitive techniques may require prior knowledge of cell-specific markers and antibodies to prepare target cells for analysis.

Dielectrophoresis (DEP) is the motion of a particle in a suspending medium due to the presence of a non-uniform electric field. DEP utilizes the electrical properties of the cell/particle for separation and identification. The physical and electrical properties of the cell, the conductivity and permittivity of the media, as well as the gradient of the electric field and its applied frequency are substantial parameters determining a cell's DEP response.

The application of dielectrophoresis to separate target cells from a solution has been studied extensively in the last two decades. Examples of the successful use of dielectrophoresis include the separation of human leukemia cells from red blood cells in an isotonic solution, entrapment of human breast cancer cells from blood, and separation of U937 human monocytic from peripheral blood mononuclear cells (PBMC). DEP has also been used to separate neuroblastoma cells from HTB glioma cells, isolate cervical carcinoma cells, isolate K562 human CIVIL cells, separate live yeast cells from dead, and segregate different human tumor cells. Other examples are described in U.S. Pat. No. 8,968,542 (“the '542 patent”), issued on Mar. 3, 2015, the entirety of which is incorporated by reference herein.

FIG. 1 is an example of DEP device 111 from the '542 patent. The DEP device 111 is formed in a substrate 119 and includes a sample channel 117 for placing the cells to be separated. Electrodes (not shown) are placed into electrode receiving portions 114,116 and electrically communicated with an electrode fluid that is added to electrode channels 113, 115. The electrode fluid in each of the electrode channel 113, 115 establishes the electric field across the sample channel 117.

While these prior DEP devices are suitable for separating cells, to function, additional modifications to the prior DEP devices are required prior to use. For example, prior DEP devices are distributed dry and the sample, buffer, and electrode solutions are added by the end-user at the point of use. In addition, the volume of the sample fluid and electrode fluid required for a DEP process is typically more than that provided by the sample channel, electrode channel, and electrode receiving portions alone. Thus, additional connectors must be added to the top of the DEP device in order to seal the fluid chambers, provide sterility, and provide support for sample fluid tubes and electrodes. The additional connectors, sample lines, and/or electrodes add additional thickness to the DEP device, which may interfere with observing the DEP device during operation through, for example, an optical microscope. In addition, certain DEP devices require soaking or preconditioning of the device prior to being used for a DEP process, which adds further set-up time. Each of these additional set-up steps introduce opportunities for variability in the DEP process and also increase the likelihood of contamination.

### BRIEF SUMMARY OF THE INVENTION

Disclosed aspects include, for example, a microfluidic package device having a substrate, a sample channel having at least one sample receiving portion and at least one outlet portion, at least one electrode channel having at least one electrode receiving portion, and a resilient layer on top of the substrate. In one disclosed aspect, the resilient layer defines at least one sample receiving well above the at least one sample receiving portion and at least one outlet well above the at least one outlet portion. In another aspect of the disclosure the resilient layer defines at least one electrode wells above that the at least one electrode receiving portion. In yet another aspect of the disclosure, the resilient layer is adhered to the substrate.

In one particular aspect of the disclosure, the resilient layer is in contact with the substrate. In another aspect of the disclosure, the least one sample receiving well and the at least one outlet well are, respectively, coaxially aligned with the at least one sample receiving portion and the at least one outlet portion. In yet another aspect of the disclosure the least one electrode well is, respectively, coaxially aligned with the at least one electrode receiving portion. In a further aspect of the disclosure the least one sample receiving well and the at least one outlet well are each defined by resilient layer cut-outs. In another aspect of the disclosure, the least one electrode well is defined by resilient layer cut-outs. And in another aspect of the disclosure the least one sample receiving well and the at least one outlet well are each adapted for holding sample fluid. In one aspect of the disclosure, at least one electrode well is adapted for holding electrode fluid. In another aspect of the disclosure a resilient layer comprises a resilient layer viewing well.

Disclosed herein are example microfluidic package holders. In one aspect of the disclosure a microfluidic package holder includes a stationary side and a movable side adapted to hold a microfluidic package. In one aspect of the disclosure the microfluidic package includes a resilient layer having at least one sample receiving well and at least one electrode well, at least one electrode, and at least one sample line. In another aspect of the disclosure a stationary side and a movable side are adapted to hold a microfluidic package such that the at least one electrode is aligned with the at least one electrode well and the at least one sample line is aligned with the at least one sample receiving well. In yet another aspect of the disclosure the stationary side and the movable side are adapted to hold the microfluidic package such that when the holder is placed into a closed position the at least one sample line and the at least one electrode are inserted through one or more side surfaces of the resilient layer and into the respective sample receiving and electrode wells.

In one particular aspect of the disclosure the stationary side and the movable side are adapted to hold the microfluidic package such that when the holder is placed into the closed position the at least one sample line and the at least one electrode are inserted through the one or more side surfaces of the resilient layer in a plane parallel to a substrate of the microfluidic package and the resilient layer. In another aspect of the disclosure a microfluidic package holder includes at least one carrier interface card for holding the at least one sample line. In one other aspect of the disclosure, the at least one carrier interface card further includes a keyed cut-out for interfacing with an alignment key. In another aspect of the disclosure a microfluidic package holder includes a package holder notch for interfacing with a microfluidic package notch of a corresponding microfluidic package. In yet another aspect of the disclosure at least one electrode includes at least one moveable electrode connected to the movable side.

### BRIEF DESCRIPTION OF THE DRAWINGS

FIG. 1 shows a prior art DEP device.

FIG. 2 shows a perspective view DEP device in accordance with disclosed embodiments.

FIG. 3 shows the DEP device of FIG. 2 in an exploded view in accordance with disclosed embodiments.

FIG. 4 shows a portion of the DEP device of FIG. 2 in accordance with disclosed embodiments.

FIG. 5 shows a portion of the DEP device of FIG. 2 in accordance with disclosed embodiments.

FIG. 6 shows a package holder with the DEP device of FIG. 2 in accordance with disclosed embodiments.

FIG. 7 shows example carrier interface cards in accordance with disclosed embodiments.

FIG. 8 shows the package holder of FIG. 6 in an inserted or operational position in accordance with disclosed embodiments.

FIG. 9 show a detail and cut-away view of the package holder of FIG. 8 in accordance with disclosed embodiments.

FIG. 10 shows a detail and cut-away view of the package holder of FIG. 8 in accordance with disclosed embodiments.

FIG. 11 shows an overhead view of the package holder and DEP device of FIG. 10 in accordance with disclosed embodiments.

FIG. 12 shows a method in accordance with disclosed embodiments.

FIG. 13 shows a method in accordance with disclosed embodiments.

### DETAILED DESCRIPTION OF THE INVENTION

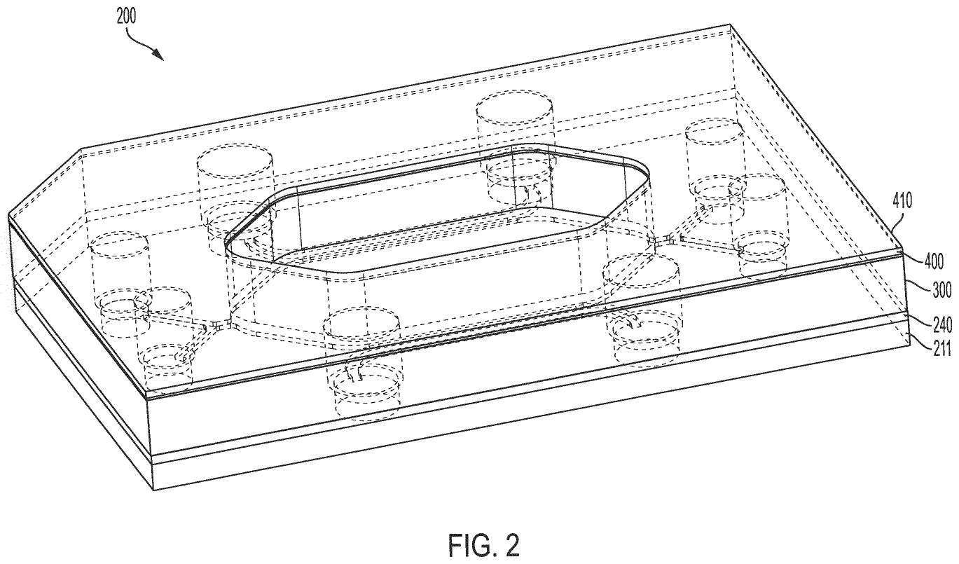

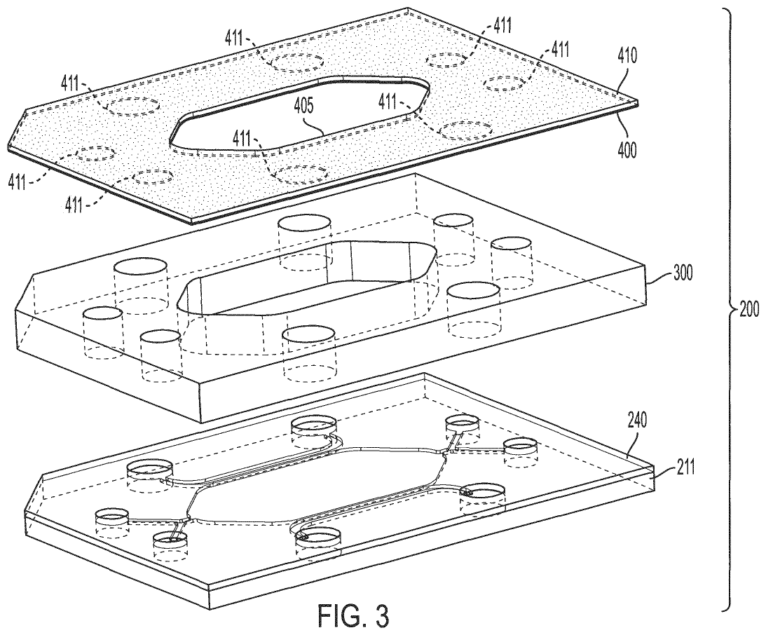

FIG. 2 shows a microfluidic package 200. Microfluidic package 200 includes a microfluidic device, which is shown, for example, as DEP device 211 as the bottom or base of the microfluidic package 200. While the remainder of this specification will be described with respect to a contactless DEP device, microfluidic package 200 may be utilized with other microfluidic chips and devices in place of DEP device 211, for example, contact DEP devices, multi-array DEP devices, multi-chamber DEP devices, high-throughput DEP devices, fluid exchange devices, cell encapsulation devices, and point-of-care devices. The DEP device 211 is sealed on its top with a transparent sealing layer 240. On top of and adhered to the transparent sealing 240 is resilient layer 300. Resilient layer 300 is sealed by top sealing layer 400. FIG. 3 Shows the microfluidic package 200 of FIG. 2 with the top sealing layer 400 and resilient layer 300 separated from DEP device 211 and transparent sealing layer 240 to show additional clarity. The Dep device 211 and layers 240, 300, and 400, will each be discussed in more detail below.

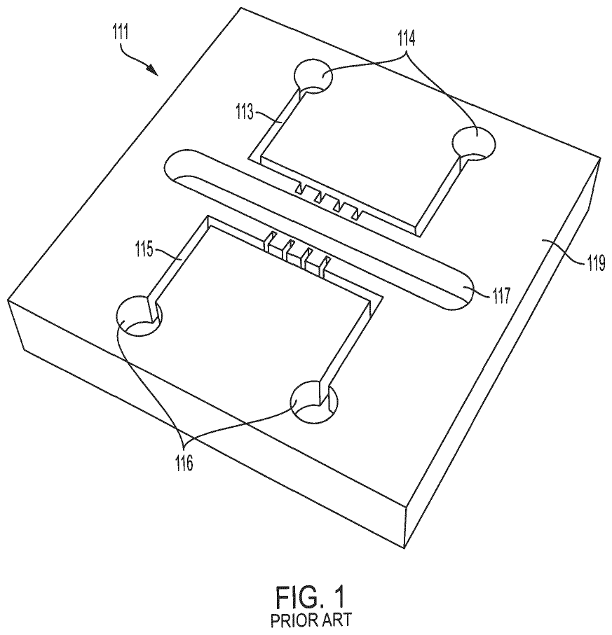

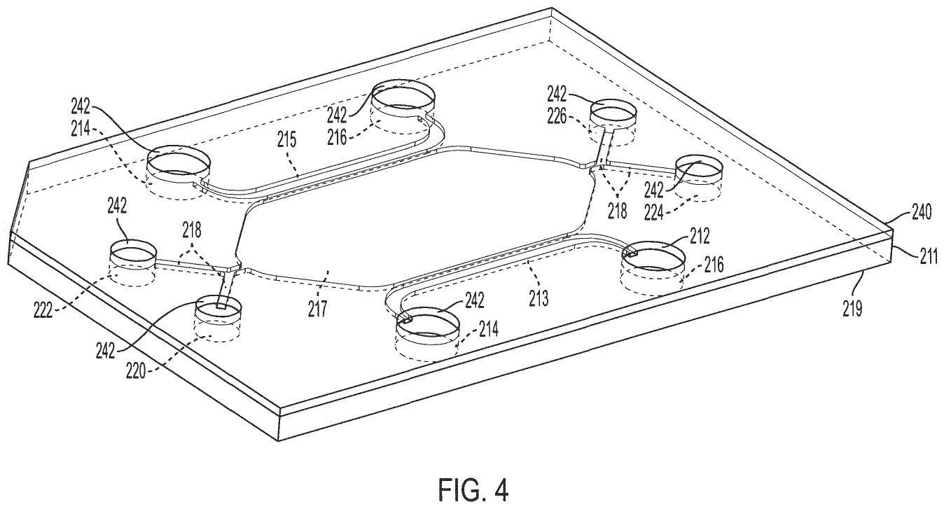

FIG. 4 shows the DEP device 211 and transparent sealing layer 240 from FIGS. 2 and 3. DEP device 211 is similar to DEP device 111, discussed with reference to FIG. 1, in that the device is formed in a substrate 119. DEP device 211 includes one or more inlet portions for receiving samples and other fluids for addition to the sample channel 217. Inlet portions, may include for example, sample receiving portion 220 and buffer receiving portion 222. A sample containing cells to be separated would, in one example, be added to the sample receiving portion 220. A buffer solution, which assists in carrying the cells across the sample channel 217, would, in one example, be added to the buffer receiving portion 222. The buffer solution may also function, at various points throughout the use of the microfluidic package 200 to maintain cell viability, establish contrasting electric fields, minimize and ejects bubbles, wash cells stuck in the channel, flush the system for fluidic pressure balance, and flush the channel between collections to minimize mixing after separation. Extension channels 218 connect the respective sample receiving portion 220 and buffer receiving portion 222 to the sample channel 217 and aide in mixing the sample with the buffer solution.

DEP device 211 also includes one or more outlet portions for removing the separated samples and other fluids from sample channel 217, which would typically be done under pressure of the input buffer and sample solutions. As shown, DEP device 211 includes first outlet portion 224 and second outlet portion 226, however, any number of outlet portions may be included based on the design of the particular microfluidic package. Depending on the particular DEP process being completed with the microfluidic package 200, one or more outlet portions may be utilized. In addition, a particular outlet portion may be used more than once for sequential collections of different types of cells.

DEP device 211 includes one or more electrode receiving portions 214, 216 for receiving electrode fluid and the electrode fluid, in operation, is in electrical communication with electrodes (not shown). The electrode fluid is further present in electrode channels 213, 215, which is in electrical communication with electrode receiving portions 214, 216. When an electrical potential is generated between electrode channels 213, 215, an electric field is established across the sample channel 217 having the desired effect on cell separation. DEP device 211 may be formed by any etching or any other means known in the art, for example those methods discussed in the '542 patent.

Affixed or otherwise bonded to DEP device 211 is transparent sealing layer 240. Transparent sealing layer 240 may be, for example, bonded to DEP device 211 through the use of thermal bonding, laser bonding, adhesive bonding, or any other bonding known in the art. In one example, as shown, transparent sealing layer 240 seals the sample channel 217, electrode channels 213, 215, and extension channels 218. Transparent sealing layer 240 may be, for example, any known transparent material that can form a suitable bond with the DEP device 211 material to prevent sample and electrode fluids from leaking out of the respective channels. In one example, the transparent sealing layer 240 includes or is made of an inert of biologically compatible material that is compatible with the electrode buffer and sample. Ideally, there is biocompatibility between the material and the sample, i.e., the material sustains viability over the sample over a long period (longer than time it take to perform the microfluidic test or separation). However, because the contact time of the sample with the transparent sealing layer 240 is relatively short during the use of DEP device 211, the material being inert is sufficient such that it is not harmful or toxic to the sample cells. Non limiting example transparent sealing layer 240 materials include one or more of the following: cyclic olefin copolymer, polydimethylsiloxane (PDMS), polymethyl methacrylate (PMMA). However, others may be used. While a number of applications can benefit from being able to see the sample channel 217, if a particular application does not require a visual inspection of the sample channel 217, then layer 240 may be substituted for a non-transparent material having similar sealing properties.

A plurality of sealing layer cut-outs 242 are spaced over, and in one example concentrically with, respective electrode receiving portions 214, 216, sample receiving portion 220, buffer receiving portion 222, first outlet portion 224, and second outlet portions 226, thus providing the only access to the DEP device 211. The sealing layer cut-outs 242 extend through the entirety of the thickness of transparent sealing layer 240. The sealing layer cut-outs 242 may be formed prior to or after affixing the transparent sealing layer 240 to the DEP device 211. In one example, sealing layer cut-outs 242 may be formed at the same time as other concentric cut-outs, which be discussed further below. The sealing layer cut-outs 242 may be punched, cut, drilled, or otherwise formed by other means known in the art.

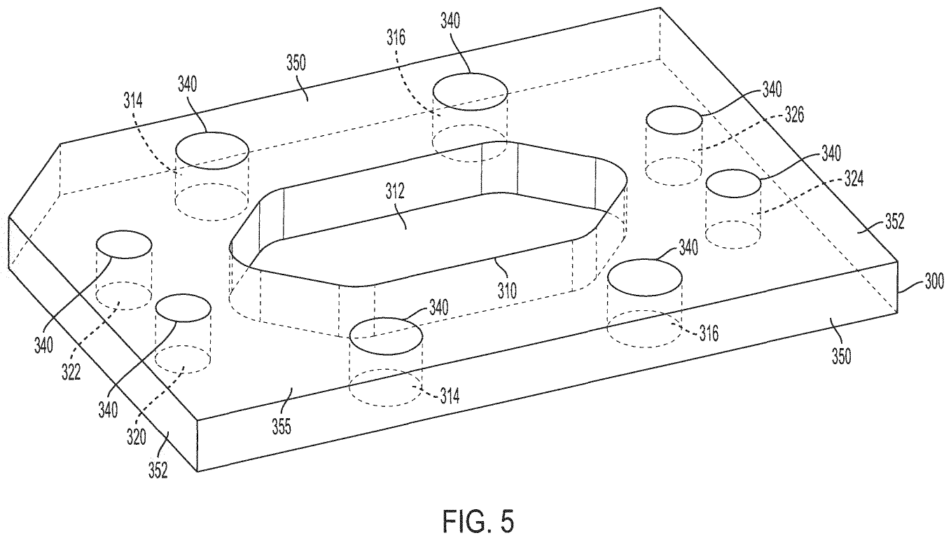

FIG. 5 shows the resilient layer 300 of the microfluidic package 200 of FIGS. 2-3. The resilient layer has about the same general form and shape of DEP device 211 (FIGS. 2-4) and transparent sealing layer 240 (FIGS. 2-4). Resilient layer 300 is formed of a resilient material that will not absorb or transport the liquids used for the sample, buffer, or electrode solutions depending on the specific microfluidic device in use at the pressure of operation. For example, a closed cell foam. The resilient layer 300 should have enough resilience such that the electrodes and lines (discussed below) are able to pierce the material but have sufficient firmness to seal the electrodes and lines against leakage of the fluid within the respective wells (discussed below). In one particular microfluidic package 200, a crosslinked polyethylene closed cell foam may be used. In another example a one-stage or two-stage foam may be used. Other non-limiting examples include polymers formed from electron beam and/or chemical crosslinking, gels, injection molding polymers having sufficient resilience, low density polyethylene foam, high density polyethylene foam, and silicone foam. As an alternative, a closed cell silicone or polyurethane foam may also be used. In one example, a closed cell foam having a density from about 2 pounds per cubic foot (PCF) to about 4 PCF may be suitable. In one example, a closed cell polyethylene foam having a density 2 PCF may be used. One example of such a foam is supplied under the tradename Volera having type EO supplied by Voltek, LLC of Coldwater, Mich. and is available in 2 PCF density. The technical data sheet associated with both examples 2 PCF and 4 PCF foams is enclosed as Appendix A to this application. Another example of a material for resilient layer is a closed cell, cross-linked polyethylene foam supplied under the tradename Plastazote LD24 supplied by Zotefoams plc. A copy of the data sheet for the Plastazote LD24 showing its associated properties is enclosed as Appendix B to this application. Other examples of materials for the resilient layer are disclosed in Appendix C, which is a list of example properties of crosslinked polyethylene foam supplied by Worldwide Foam, Elkhart, Ind. and a cross reference sheet indicating which Worldwide Foam material is compatible with other suppliers.

The thickness of the resilient layer 300 should be larger than the diameter of the input and output lines and electrodes to be used with the microfluidic package 200, which will be discussed below. As an alternative, only a portion of the resilient layer 300 is resilient. For example, the main body of the resilient layer may injection molded out of a thermoplastic. In such an example, duck-bill valves, or other valves allowing for the insertion of electrodes and input/output lines may be inserted between the outside surfaces of the resilient layer and the respective wells.

A plurality of resilient layer cut-outs 340 are spaced over, and in one example concentrically with, respective electrode receiving portions 214, 216, and sealing layer cut-outs 242. The sealing layer cut-outs 242 extend through the thickness of the resilient layer 300 and respectively form a plurality of wells, e.g., electrode wells 314, 316, sample receiving well 320, buffer receiving well 322, first outlet well 324, and second outlet well 326 (“wells”), over the respective receiving portions of DEP device 211, e.g., electrode receiving portions 214, 216, sample receiving portion 220, buffer receiving portion 222, first outlet portion 224, and second outlet portion 226. In addition, resilient layer 300 includes a resilient layer viewing cut-out 310 in the shape of the sample channel 217 to forms a resilient layer view well 312, which provide visual access to the sample channel 217 (through the transparent sealing layer 240) (FIG. 4).

The wells 314, 316, 320, 322, 324, and 326 serve as fluid reservoirs for the electrode, sample, and buffer solutions and their respective sizes will depend on the particular volumes needed for each application. In one example, the resilient layer 300 is made from ⅛-inch-thick closed cell foam and the electrode wells 314,316 have a volume of about 39.9 cubic millimeters (mm³) and the sample receiving well 320, buffer receiving well 322, first outlet well 324, and second outlet well 326 each have a volume of about 22.44 mm³. However, the size of each well may be larger or smaller depending on the application. For example, higher volume wells would also be usable for higher throughput devices and lower volume wells would also be usable for precision targeting of cells. The resilient cut-outs 340 and respective wells 314, 316, 320, 322, 324, and 326 may be punched, cut, drilled, or otherwise formed by other cutting means prior to or after affixing the resilient layer 300 to the transparent sealing layer 240. In addition, the resilient layer cut-outs 340 may be formed in place and at the same time as sealant layer cut-outs 242 (FIG. 4), for example by punching or drilling the resilient layer 300 and transparent sealing layer 240 in place. The resilient layer 300 may be affixed or bonded to the DEP device 211/transparent sealing layer 240 by any known method, including, for example, solvent bonding or adhesive. In one example, the resilient layer 300 has a pressure sensitive adhesive, such as 9471-LE (low energy) adhesive supplied by 3M, on its bottom surface (i.e., between the transparent sealing layer 240 and the resilient layer 300) for adhering the resilient layer 300 to the transparent sealing layer 240. A copy of the data sheet for 9775WL, another example adhesive tape that may be used, as well as similar adhesives, is enclosed as Appendix D, although this disclosure is not limited to those adhesives alone. However, other adhesives as well, as glues (including hot melt glues), may also be used. In one example the pressure sensitive adhesive is applied to a thickness of about 0.005 inches.

With reference back to FIG. 3, above the resilient layer is top sealing layer 400. Top sealing functions to seal the tops of wells 314, 316, 320, 322, 324, and 326. The top sealing layer 400 is solid across the entirety of the surface. However, optionally, a top sealing layer sample observation cut-out 405 may be included to allow visual inspection, e.g. via a microscope. The top sealing layer sample observation cut-out 405 allows fora microscope element to protrude past the top sealing layer 400 and closer to DEP device 211, allowing for closer inspection and more optical focal lengths, which can improve the accuracy of the DEP device 211. The top sealing layer sample observation cut-out 405 may be formed as discussed above with reference to the cut-outs of the resilient layer 300 and transparent sealing layer 240. The top sealing layer may be made from any material capable of obtaining a suitable fluid seal with the top of resilient layer 300. Certain advantages can be obtained by using a transparent top sealing layer 400, which include being able to visually verify the placement of electrodes and input and output lines, discussed below. In one example, a transparent top sealing layer 400 includes a polyester film, for example, polycarbonate, polyethylene terephthalate or biaxially-oriented polyethylene terephthalate, which is sold under the tradename Mylar. Top sealing layer 400 may be affixed to the resilient layer 300 using any adhesion or bonding known in the art. In one example, the top sealing layer 400 is adhered to resilient layer 300 using an adhesive layer of pressure sensitive adhesive having a thickness of about 0.005 inches.

A label layer 410 may optionally be included on the top side of top sealing layer 400, i.e. on the opposite side of top sealing layer 400 from resilient layer 300 as shown in FIG. 3. As an alternative, the label layer 410 may optionally be included between the top sealing layer 400 and the resilient layer 300. Label layer 410 may be an ink layer printed onto either side of the top sealing layer 400 or it may be a separate label that is affixed or otherwise adhered to the top sealing layer 400, for example a label on an adhesive paper or polymer substrate. For example, a separate label layer may be printed on 0.005-inch-thick Teslin, a synthetic paper manufactured by PPG, and then laminated to the bottom of top sealing layer 400 using a 0.005 inch thick adhesive. In another example, a label layer 410 may include a frosted or gloss polyester laminated to the to the top of top sealing layer 400. The top sealing layer sample observation cut-out 405 may optionally also cut through label layer 410 to provide the advantage discussed above. Label layer 410 may label any portion of the surface area of the microfluidic chip as desired by a particular application. For example, as shown in in FIG. 3, the label layer 410 has label cut-outs 411, which are areas where no label or “ink” is applied providing the end user with a view into each of the respective wells 314, 316, 320, 322,324, and 326 beneath. However, not all label cut-outs need to be used. For example, in another embodiment, the label cut-outs 411 over the electrode wells 314, 316 are omitted for simplicity. Other useful features will become apparent in view of this disclosure. For example, the label layer 410 may contain useful labels for each of the wells including identifying information for the sample receiving well 320, buffer receiving well 322, first outlet well 324, and second outlet well 326, and may include information about the type of microfluidic package 200 or respective test the microfluidic package 200 should be used with, may include serial number and/or lot number, and the respective manufacturer of the microfluidic package 200 as just some examples.

The microfluidic package 200 has a number of advantages over the prior art. First, the wells 314, 316, 320, 322, 324, and 326 have sufficient volume to prevent the need for external attachments. In addition, the well volumes are variable based on the thickness of the resilient layer 300 and the diameter the resilient layer cut-outs 340, to provide an integrated sealed fluid reservoir having a sufficiently sized reservoir for the particular DEP device 200. Because there are integrated sealed fluid reservoirs (wells), electrode fluid may be installed at the time of manufacture, for example in electrode wells 314,316, electrode receiving portions 214, 216, and/or electrode channel 213, 215. In addition, the microfluidic package 200 may be pre-filled with buffer solution, for example in the sample receiving well 320, buffer receiving well 322, first outlet well 324, second outlet well 326, sample channel 217, sample receiving portion 220, buffer receiving portion 222, first outlet portion 224, second outlet portion 226, and/or extension channels 218. Any pre-filled portion of the microfluidic package 200 reduces the time needed to prepare the microfluidic package 200, thus increasing the efficiency of the end-user. In addition, there is a decreased likelihood of the microfluidic package 200 being contaminated by the end-user or end-user environment. Further, it can be advantageous to soak or pre-condition the DEP device 211 for a period of time prior to use in order to reduce sample channel 217 fouling. By having a sealed microfluidic package 200, the microfluidic package may be pre-soaked or pre-conditioned prior to arriving to an end-user. In another embodiment, relevant portions of the microfluidic package 200 can be filled at the time of manufacture with a low surface tension fluid, for example, an alcohol, to purge or prevent the formation of air pockets, which could decrease the effectiveness of the DEP device 211, within the microfluidic package 200. As will be discussed below, the resilient layer 400 enables the introduction of electrodes and sample and buffer input and outlet lines through the long and short side surfaces 350, 352 (FIG. 5), respectively, of resilient layer 300, such that the electrodes and sample and buffer input and outlet lines are introduced generally parallel to the planar surface 355 of the resilient layer 300. Such an orientation does not add to the thickness of the microfluidic package 200 and enables unobstructed visual inspection of the DEP device 211 at more optimal microscopic focal lengths.

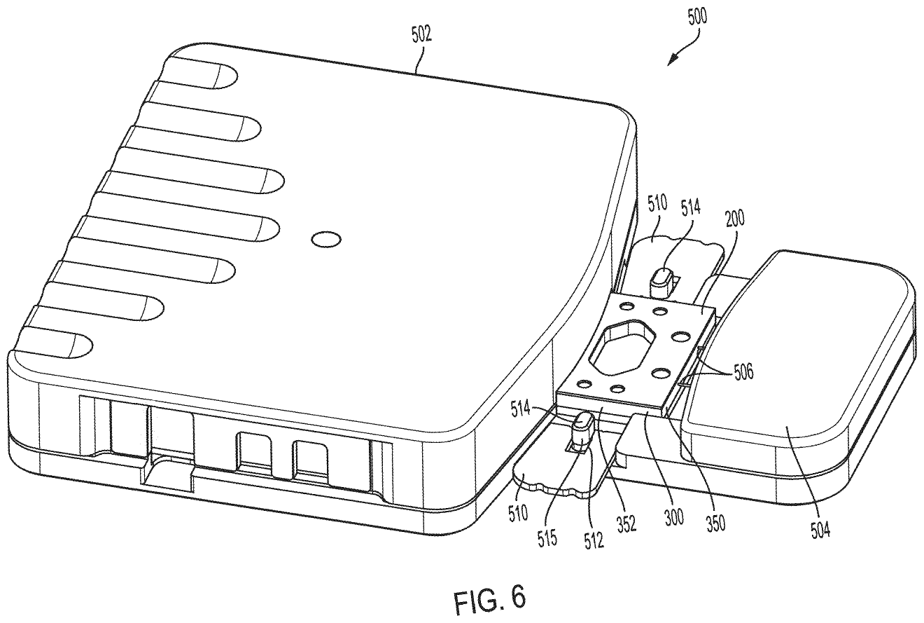

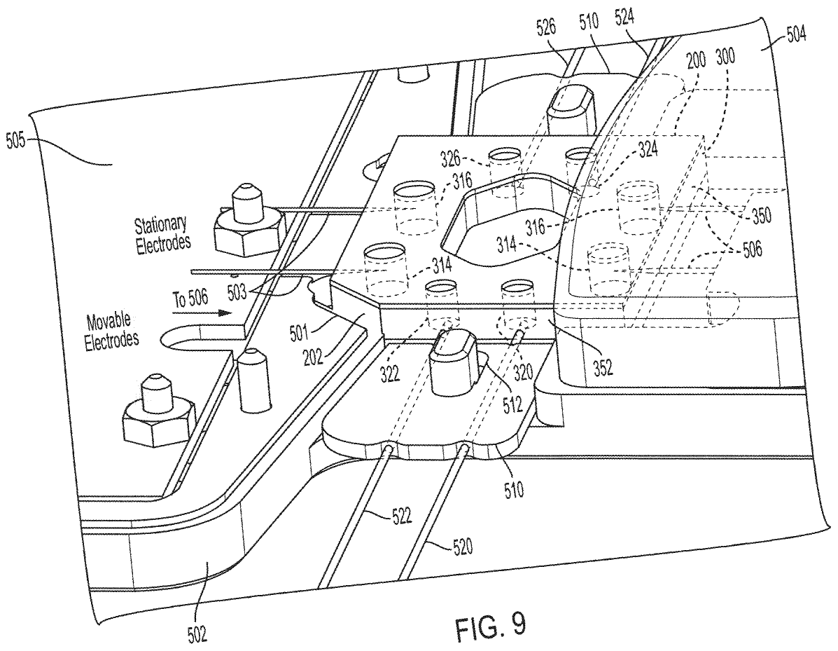

FIG. 6 shows a package holder 500 for interfacing and using the microfluidic package 200. The package holder 500 includes a stationary side 502 and a moveable side 504. For the microfluidic package 200 shown, the stationary and movable sides 502, 504 each include two electrodes, with only the two moveable electrodes 506 visible in this view. The electrodes on each of the stationary and movable sides 502,504 are for insertion through resilient layer 300 long side surfaces 350 (FIG. 5). While the movable side 504 is in the retracted position as shown in FIG. 6, the microfluidic package 200 can be inserted into the package holder 500. The microfluidic package 200 may include a keyed notch 200 (FIG. 2) that corresponds to a notch 501 (FIG. 9) in the package holder 500 for aiding in alignment and preventing insertion of the microfluidic package 200 in an improper orientation. Stationary side 502 of package holder 500 is shown including the electrode interface circuitry 505 for electronically driving the electrode and interfacing the electrodes to control circuitry (not shown). It should be noted that electrode interface circuitry 505 may also be installed elsewhere in the package holder 500 in electrical communication with electrodes 503, 506.

Also shown in a retracted position are carrier interface cards 510, which hold and align input and output lines, described below. Carrier interface cards 510 may include a keyed cut-out 512 that matches alignment keys 514 of the package holder. Each alignment key 514 may include an alignment key notch 515 that further acts to hold and stabilize the carrier interface cards 510 while also functioning as a positive stop to ensure the carrier interface cards are inserted fully but not over-inserted. In addition, the carrier interface cards 510 in combination with the alignment keys 514 provide a strain relief function for the input and output lines. The alignment keys hold the carrier interface cards 510 against the microfluidic package 200 so the input and output lines will not pull out of the microfluidic package 200 if tugged upward or otherwise moved.

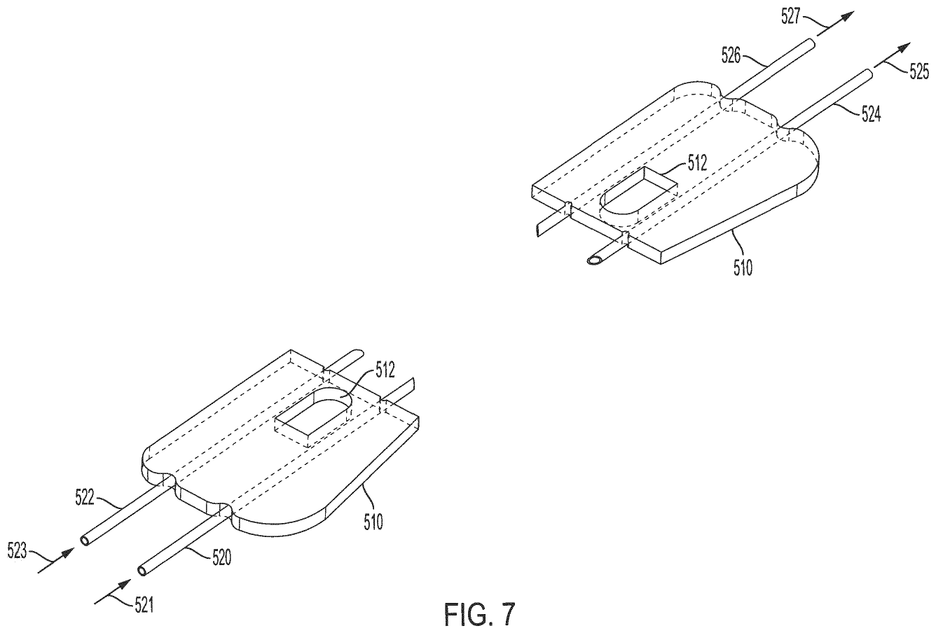

FIG. 7. Shows the two carrier interface cards 510 shown in FIG. 6. The carrier interface cards 510 hold the respective lines for carrying liquids to and from microfluidic package 200 (FIG. 6). For example, carrier interface cards 510 can include a sample input line 520 for fluidically transferring a sample containing fluid 521, a buffer input line 522 for fluidically transferring a buffer solution 523 (or other sterilization, preparation, washing, or post-treatment solution), a first outline line 524 for fluidically transferring a first outlet solution 525, and a second outlet line 526 for fluidically transferring a second outlet solution 527 (together, “lines”). The lines, 520, 522, 524, 526 may be sized appropriately for the microfluidic package 200 application. In one example, the lines 520, 522, 524, 526 are about 0.125 inch internal diameter tubing having a wall thickness of about 0.040 inches thick. In another example, the lines 520, 522, 524, 526 have an internal diameter of about 0.030 inches and an outer diameter of about 0.060 inches. The wall of the lines 520, 522, 524, 526 should have sufficient thickness or rigidity to not collapse when pushing tubing into the resilient layer 300. The carrier interface cards 510 may be formed of any material sufficiently firm enough to support the lines 520, 522, 524, 526 and to maintain sufficient registration between keyed cut-out 512 and alignment key 514 (FIG. 6.). For example, any rigid polymer would be sufficient. In one example, the carrier interface cards 510 are each formed of two adhesive backed polycarbonate sheets each having a thickness of about 0.020 inches and adhered to each other with the lines 520, 522, 524, 526 in between. The carrier interface cards 510 may be joined to the lines 520, 522, 524, 526 by the end-user or may be manufactured as a set, e.g., sent to the send-user with the lines 520, 522, 524, 526 pre-installed, which increases repeatability and accuracy of line placement within the microfluidic package 200 (FIG. 6).

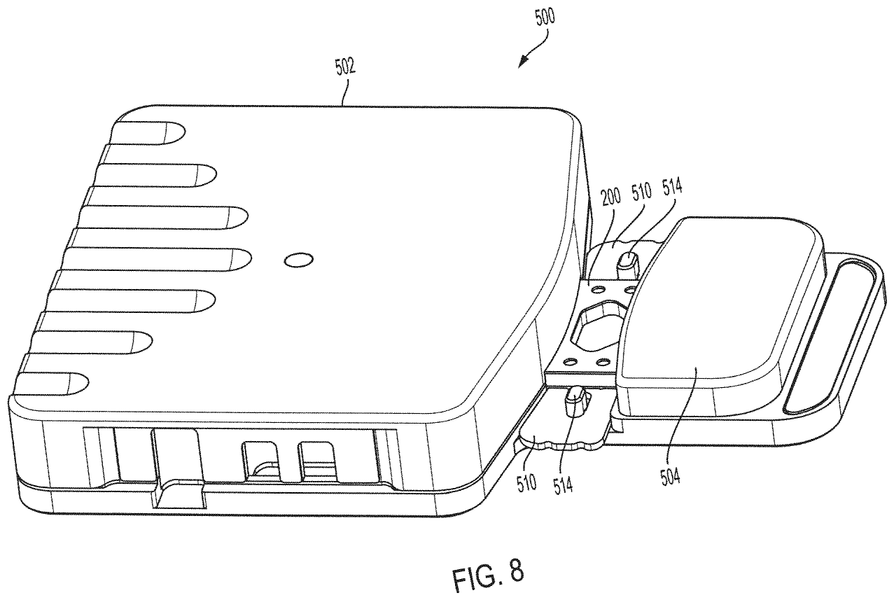

FIG. 8 shows the package holder 500 of FIG. 6, however, as shown, the movable side 504 has been shifted toward the stationary side 502 and each of the carrier interface cards 510 have been engaged into their inserted positions. It should be noted that the lines 520, 522, 524, 526 have been omitted for clarity.

FIG. 9 shows the package holder 500 of FIG. 8 with a portion of the stationary side 502 housing removed to show detail. In operation, the microfluidic package 200 is inserted into the package holder 500 with the microfluidic package notch 202 corresponding to the package holder notch 501 to ensure proper alignment. The keyed cut-outs 512 of the carrier interface cards 510 are placed over the alignment keys 512 and each of the carrier interface cards are inserted towards the microfluidic package 200, which causes the lines 520, 522, 524, 526 to pierce each of the short side surfaces 352 of the microfluidic package 200 such that the lines 520, 522, 524, 526 are each inserted into the respective wells 320, 322,324,326.

After or prior to the insertion of the carrier interface cards 510, the moveable side 504 is shifted towards the stationary side 502 of the package holder 500, which causes the microfluidic package 200 to be pushed against the stationary electrodes 503 and the moveable electrodes to be pushed against the microfluidic package 200. The relative movement between the moveable side 504, the stationary side 502, and the microfluidic package 200 cause each of the stationary electrodes 503 and moveable electrodes 506 to be inserted through the long side surfaces 350 of the resilient layer 300 of microfluidic package 200 and into the respective electrode wells 314, 316. The stationary side 502 may include electrode interface circuitry 505 in the form, for example, of a printed circuit board and appropriate electrical interface connections to the stationary electrodes 503, the moveable electrodes 506 (through the package holder 500 and moveable side 504) and to appropriate driver and control circuity (not shown) for driving the electrodes 503, 506 to appropriate electrical characteristics and/or waveforms for the particular microfluidic package 200.

Sample input line 520 and buffer input line 522 are each fluidically connected to appropriate liquid reservoirs and pressure systems known in the art. For example, sample input line 520 and buffer input line 522 may each be fluidically connected to a syringe, which is driven by an appropriate syringe pump for controlling the flow of sample and buffer fluid through the microfluidic package 200. As the sample fluid enters the microfluidic package and traverses the sample channel 217 (FIG. 4), cells in the sample fluid are affected by the electric field generated between the electrode channels 213,215 (FIG. 4) according to the particular DEP device 211, fluid flow settings, and electric field characteristics. For example, one or more types of cells in the sample fluid may be separated into first outlet well 324 second outlet well 326 and then removed via first outlet line 524 second outlet line 526, respectively, under pressure from the syringe pumps.

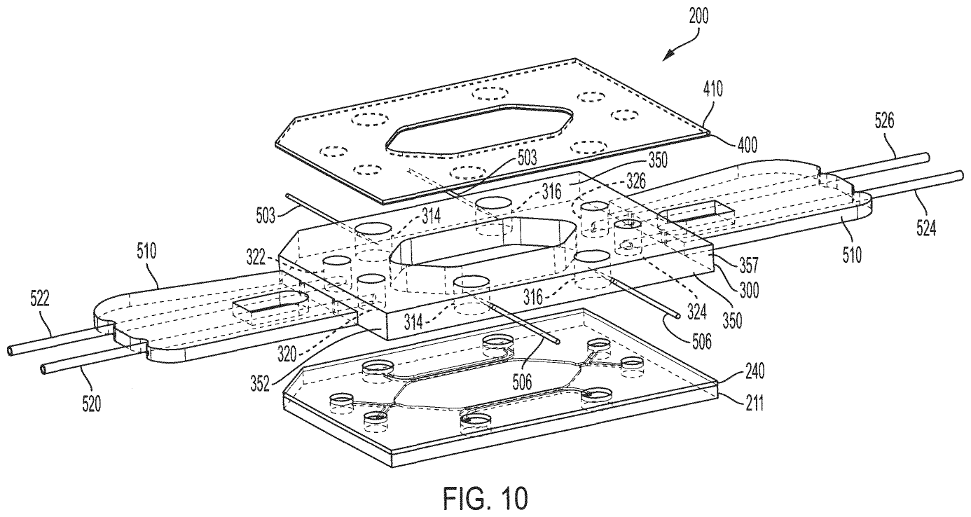

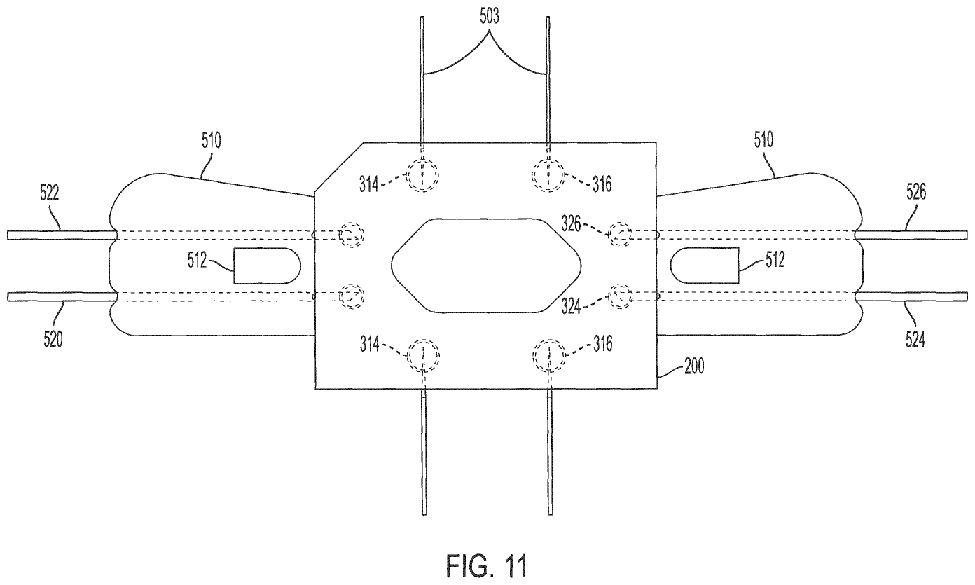

FIGS. 10-11 show different views of electrodes 503, 506 and lines 520, 522, 524, and 526 in the inserted or operational position with respect to microfluidic package 200. FIG. 10 shows an exploded view of microfluidic package 200 to show the interfaces with resilient layer 300. FIG. 11 shows a top view of microfluidic package 200 to show the placement of electrodes 503, 506 and lines 520, 522, 524, and 526 inside the respective wells, 314, 316, 320, 322, 324, 326, respectively, when in the inserted position. Once the carrier interface cards 510 and moveable side 504 are shifted into the inserted (or operational) position, the electrodes 503, 506 pierce the long side surfaces 350 of the resilient layer 300 and enter the respective electrode wells 314, 316 and the lines 520, 522, 524, and 526 pierce the short side surfaces 352 of the resilient layer 300 and enter the respective wells (sample receiving well 320, buffer receiving well 322, first outlet well 324, second outlet well 326). It should be noted that each of the lines 520, 522, 524, and 526 may include a chamfered or pointed tip to aid penetration of the resilient layer. Similarly, the electrodes 503, 506 may also be similarly chamfered or pointed. While the example embodiments are described having the electrodes enter the long side surface 350 of resilient layer 300 and the lines 520, 522, 524, and 526 enter the short side surface 352, in another embodiment, the electrodes and corresponding electrode wells are configured on the short side surface of the resilient layer and the lines and respective wells are configured on the long side surface of the resilient layer.

In addition to the benefits described above with respect to the microfluidic package 200, when the microfluidic package 200 is used in conjunction with the package holder 500, the sterility of the microfluidic package can be maintained because only small punctures in the resilient layer 300 are needed to for fluidic or electrical connections, there is no need for additional external connectors as described in the prior art. In addition, because the respective wells, electrodes, and lines are pre-aligned, there are fewer opportunities for misalignment and an increased likelihood of having a repeatable test. Further, the user of the package holder 500 is less exposed to electrical conductivity from electrodes sticking out of added connectors.

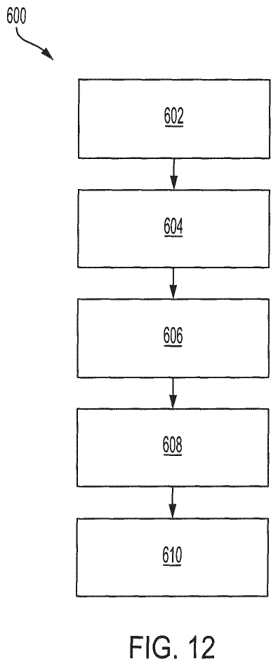

FIG. 12 shows a method 600 of forming a microfluidic package 200. At step 602 a DEP device 211, or other microfluidic chip, is formed, for example as disclosed in the '542 patent. At step 604 a transparent sealing layer 240 is affixed to the DEP device 211 and sealing layer cut-outs 242 are formed, either prior to or after affixing the transparent sealing layer 240 to the DEP device 211. At step 608 resilient layer 300 is affixed to the transparent sealing layer 240 resilient layer cut-outs 340 and resilient layer viewing cut-outs 310 are formed, either prior to or after affixing the resilient layer 300 to the transparent sealing layer 240. At step 610, the top sealing layer 400, and, if included, the label layer 410 with desired label cut-outs 411 are affixed to the resilient layer 300.

FIG. 13 shows a method 700 of using microfluidic package 200. At step 702, a microfluidic package 200, a package holder 500, and one or more carrier interface cards 510 having one or more fluid lines are provided. At step 704 the microfluidic package 200 is inserted into the package holder 500, and, if included, the microfluidic package notch 202 is matched to the Package holder notch 501 to obtain the correct orientation. At step 706, the moveable side 504 is shifted towards the microfluidic device, which can be slide as shown or swung, tipped, or rotated into place in alternative embodiments, causing the stationary and moveable electrodes 503, 506 to pierce the resilient layer 300 of the microfluidic device 200 and enter the respective electrode well. This also functions to align the microfluidic device 200 at the appropriate location for receiving the in the input and output lines. At step 708, the carrier interface cards 510 are inserted such that the keyed cut-out 512 is placed over the alignment key 514 and each of the carrier interface cards are shifted towards the microfluidic device such that lines pierce the resilient layer 300 of the microfluidic device 200 and enter the respective well. At step 710, the appropriate microfluidic program is executed causing an appropriate syringe pump to pump liquid through the microfluidic device 200 and the electrodes to emit an appropriate electric field. It should be noted that the disclosed methods and devices are not limited to any particular microfluidic process and that a skilled artisan would understand that different microfluidic processes may require different flow rates and electrode setting, which would be able to be determined by a person of ordinary skill in the relevant art.

As an alternative to inserting the electrodes and lines into the resilient layer, the resilient layer and all of the layers above the resilient layer may be replaced with a more permanent interface layer that is part of the package holder. In such an alternative, the interface layer which would remain in place with the package holder having the electrodes and lines installed into wells within the interface layer. The electrodes and lines may be similarly installed parallel to the top face of the interface layer. The interface layer may be made out of a plastic, metal, or resilient material as discussed above. In such an example, a microfluidic device would be placed into the package holder and the interface layer would be sealed against the top of the microfluidic device prior to initiated use of the microfluidic device. Such a configuration maintains a number of the benefits of the above discussed examples while also providing additional flexibility as to use of the package holder.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed as new and desired to be protected by Letters Patent of the United States is:

1. A microfluidic package device comprising:
a substrate;
a sample channel having at least one sample receiving portion and at least one outlet portion;
at least one electrode channel having at least one electrode receiving portion;
a resilient layer on top of the substrate,
wherein the resilient layer defines at least one sample receiving well above the at least one sample receiving portion and at least one outlet well above the at least one outlet portion;
wherein the resilient layer defines at least one electrode wells above that the at least one electrode receiving portion.

2. The microfluidic package device of claim 1, wherein the resilient layer is adhered to the substrate. 3 . The microfluidic package device of claim 1, wherein the resilient layer is in contact with the substrate.

4. The microfluidic package device of claim 1, wherein the least one sample receiving well and the at least one outlet well are, respectively, coaxially aligned with the at least one sample receiving portion and the at least one outlet portion.

5. The microfluidic package device of claim 1, wherein the least one electrode well is, respectively, coaxially aligned with the at least one electrode receiving portion.

6. The microfluidic package device of claim 1, wherein the least one sample receiving well and the at least one outlet well are each defined by resilient layer cut-outs.

7. The microfluidic package device of claim 1, wherein the least one electrode well is defined by resilient layer cut-outs.

8. The microfluidic package device of claim 1, wherein the least one sample receiving well and the at least one outlet well are each adapted for holding sample fluid.

9. The microfluidic package device of claim 1, wherein the at least one electrode well is adapted for holding electrode fluid.

10. The microfluidic package device of claim 1, wherein the resilient layer comprises a resilient layer viewing well.

11. A microfluidic package holder comprising:
a stationary side and a movable side adapted to hold a microfluidic package, wherein the microfluidic package includes a resilient layer having at least one sample receiving well and at least one electrode well;
at least one electrode; and
at least one sample line,
wherein the stationary side and the movable side are adapted to hold the microfluidic package such that the at least one electrode is aligned with the at least one electrode well and the at least one sample line is aligned with the at least one sample receiving well.

12. The microfluidic package holder of claim 11, wherein the stationary side and the movable side are adapted to hold the microfluidic package such that when the holder is placed into a closed position the at least one sample line and the at least one electrode are inserted through one or more side surfaces of the resilient layer and into the respective sample receiving and electrode wells.

13. The microfluidic package holder of claim 12, wherein the stationary side and the movable side are adapted to hold the microfluidic package such that when the holder is placed into the closed position the at least one sample line and the at least one electrode are inserted through the one or more side surfaces of the resilient layer in a plane parallel to a substrate of the microfluidic package and the resilient layer.

14. The microfluidic package holder of claim 11, further comprising at least one carrier interface card for holding the at least one sample line.

15. The microfluidic package holder of claim 14,wherein the at least one carrier interface card further comprises a keyed cut-out for interfacing with an alignment key.

16. The microfluidic package holder of claim 11, further comprising a package holder notch for interfacing with a microfluidic package notch of a corresponding microfluidic package.

17. The microfluidic package holder of claim 11, wherein the at least one electrode includes at least one moveable electrode connected to the movable side.
